(19) United States
(12) Patent Application Publication
(10) Pub. No.: US 2009/0032610 A1
(43) Pub. Date: Feb. 5, 2009

(54) Anti-Drip fluid delivery device

(76) Inventor: Michael Scot Rosko, Greenwood, IN (US)

Correspondence Address: Delta Faucet Company c/o MASCO Corporation;Leon E. Redman, Esq., 21001 Van Born Road, Taylor, MI, 48180, US

(21) Appl. No.: 11/881,600

(22) Filed: Jul. 30, 2007

(51) Int. Cl. B05B 1/12; B05B 1/00; B05B 1/16

(52) U.S. Cl. 239/11; 239/443; 239/583

(57) ABSTRACT

A power sprayer or spray device for use with a faucet. The spray device diminishes the tendency of water to emanate therefrom when not activated.

### BACKGROUND AND SUMMARY OF THE INVENTION

The present invention relates to a power sprayer or side spray of the type used in connection with a kitchen faucet and, more particularly, to a power sprayer including an anti-drip feature.

According to an illustrative embodiment of the present disclosure, a spray device includes a body having a fluid inlet and a first fluid outlet selectively in fluid communication with the fluid inlet, and a substantially planar screen extending within a first plane. The spray device defines a flow path between the fluid inlet and the first fluid outlet, the flow path including a portion within the screen such that fluid is directed substantially along the first plane before passing through the first fluid outlet.

According to a further illustrative embodiment, a spray device includes a body supporting first and second substantially planar surfaces, and a substantially planar screen supported within the body. The screen defines a first plane and includes first and second sides, wherein all portions of the screen are closely positioned relative to one of the first and second substantially planar surfaces, the first and second substantially parallel surfaces extending parallel to the first plane, such that fluid flow through the screen is substantially directed parallel to the first plane.

According to another illustrative embodiment, a method of increasing sites for surface tension within a spray device includes the steps of providing a hand-held sprayer body including an inlet and an outlet, and providing a gasket within the sprayer body to alter a flow path within the spray device from the inlet to the outlet.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is perspective view of an illustrative embodiment spray device of the present disclosure;

FIG. 2 is an exploded perspective view of the spray device of FIG. 1, showing a first embodiment spray head;

FIG. 3 is a partial cross-sectional view of the head of the spray device of FIG. 1;

FIG. 4 is a perspective view of a first embodiment insert of the spray device of FIG. 1;

FIG. 5 is a perspective view of a second embodiment insert used as an alternative to the first embodiment insert of FIG. 4;

FIG. 6 is a perspective view of a third embodiment insert used as an alternative to the first and second embodiment inserts of FIG. 4 and 5;

FIG. 7 is a plan view of a second embodiment spray head utilizing the second embodiment insert of FIG. 5;

FIG. 8 is a plan view of a third embodiment spray head utilizing the third embodiment insert of FIG. 6; and

FIG. 9 is a cross sectional perspective view of a fourth embodiment spray head.

### DETAILED DESCRIPTION OF THE DRAWINGS

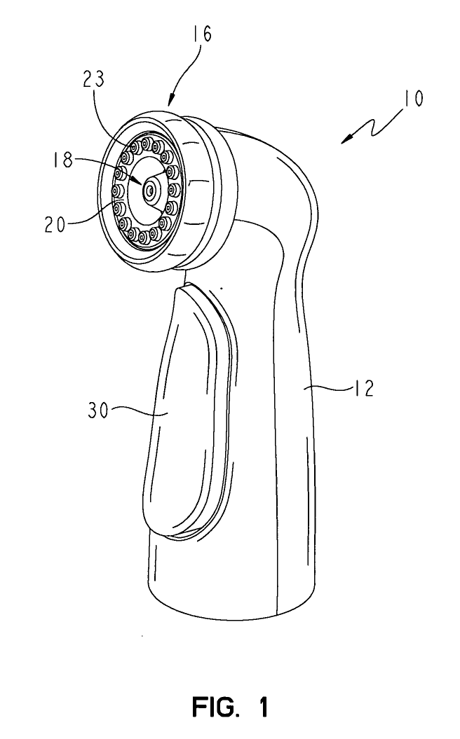

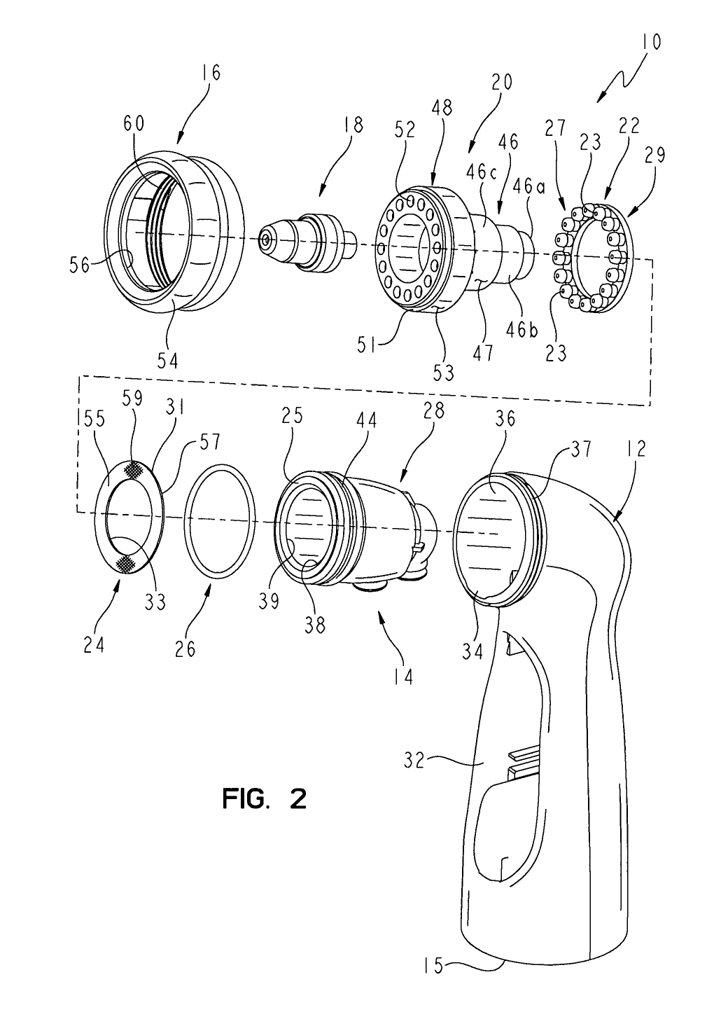

Referring initially to FIGS. 1-3, illustrative embodiment power sprayer or spray device 10 includes hand-held sprayer body 12 and spray head 14 coupled to sprayer body 12. Illustratively, spray head 14 includes securing ring 16, stream nozzle 18, body 20, annular ring 22, screen 24, seal ring 26, and insert 28.

Sprayer body 12 includes fluid inlet 15, outer threading 37, trigger opening 32 and head opening 34 that provide access to inner chamber or void 36. Trigger opening 32 receives trigger 30 therein. Head opening 34 at least partially receives spray head 14 therein. Outer threading 37 is located circumferentially about head opening 34 to mate with inner threading 60 of securing ring 16.

Trigger 30 (see FIG. 1) is supported by sprayer body 12 and may be operably coupled to an activation valve assembly (not shown) housed within inner void 36 in order to control the flow of water to a diverter valve assembly (not shown) from inlet 15, which may be coupled to a conventional water supply. Trigger 30 may be actuated by one or more fingers of the operator. Illustratively, trigger 30 dictates a first flow pattern upon depression to a first depth and dictates a second flow pattern upon depression to a second depth that is deeper than the first depth. Trigger 30 does not require the operator to release spray device 10 to actuate. In one illustrative embodiment, the activation valve assembly coupled to trigger 30 may be similar to that disclosed in co-pending U.S. patent application Ser. No. 11/702,867, filed Feb. 6, 2007, entitled “POWER SPRAYER CONTROL MECHANISM,” the disclosure of which is expressly incorporated by reference herein.

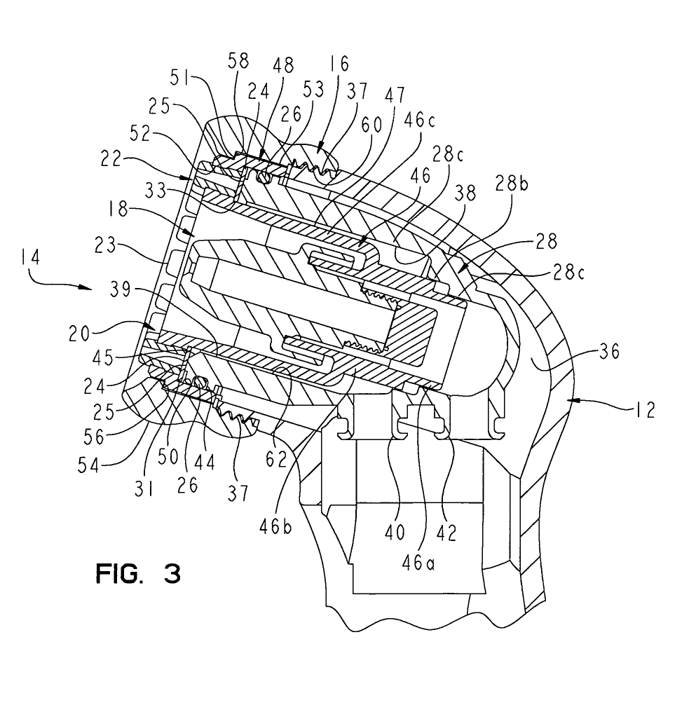

Insert 28 includes multi-diametered inner chamber or void 38. Inner void 38 includes output passageway 39, first input passageway 40, and second input passageway 42. Inner void 38 is sized to at least partially receive stream nozzle 18 and body 20 therein via output passageway 39. First input passageway 40 forms part of the first flow pattern selectively dictated by trigger 30. Second input passageway 42 forms part of the second flow pattern selectively dictated by trigger 30. Insert 28 also includes annular channel 44 disposed on the exterior thereof proximate output passageway 39. Channel 44 is sized and shaped to at least partially receive seal ring 26 therein. Seal ring 26 partially extends out of channel 44 to provide a seal between insert 28 and body 20 when body 20 is received within inner void 38. Insert 28 is sized and shaped to seat within head opening 34 of sprayer body 12. An angled portion or chamfer 45 is formed proximate the output passageway 39 adjacent a substantially planar end 25 of the insert 28 (FIGS. 3 and 4).

Body 20 includes multi-diametered trunk portion 46 and head portion 48. More particularly, trunk portion 46 includes sections 46a, 46b, 46c of different cross-sectional diameters that substantially correspond to sections 28a, 28b, 28c defining multi-diametered inner void 38 of insert 28. Sections of trunk portion 46 are sized to provide gaps between body 20 and insert 28 at certain locations, and to provide a water-tight fit between body 20 and insert 28 at other locations, as described in more detail below. Head portion 48 includes an annular inner surface 50 sized to engage seal ring 26 disposed within channel 44, and an annular outer surface 53. A shoulder 51 is defined by the outer surface 53 and is sized to engage securing ring 16. A plurality of spray outlet bores 52 are sized to receive spray outlets 23 of annular ring 22 therethrough.

Annular ring 22 includes spray outlets 23 extending from a first side 27 that abuts body 20 and a substantially planar second side 29 that is closely positioned relative to screen 24. Screen 24 is an annular screen forming a ring having an outer diameter substantially equal to the largest outer diameter of insert 28 and having an inner diameter substantially equal to the largest diameter of trunk portion 46, as shown in FIG. 3. In other words, annular outer surface 31 of screen 24 is positioned proximate inner surface 50 of head portion 48 of body 20, while inner annular surface 33 of screen 24 is positioned proximate an outer surface 47 of section 46c of trunk portion 46 of body 20. Screen 24 further includes opposing substantially planar side surfaces 55 and 57 wherein a plurality of openings 59 extend perpendicular to surfaces 55 and 57.

Securing ring 16 has a contoured outer surface 54 and a multi diametered inner surface 56. Multi-diametered inner surface 56 includes shoulder 58 sized, shaped, and located to engage shoulder 51 of head portion 48 of body 20. Multi-diametered inner surface 56 also includes threaded portion 60 located to engage outer threading 36 of sprayer body 12.

In assembly, shown in FIG. 3, insert 28 is placed within inner void 36 via head opening 34 to align first and second input passageways 40 and 42 with appropriate portions of the diverter valve assembly. Side surface 57 of annular screen 24 is closely positioned relative to substantially planar end 25 of insert 28 containing output passageway 39. Annular ring 22 is placed within head portion 48 of body 20 such that spray outlets 23 extend through spray outlet bores 52. Trunk portion 46 of body 20 with stream nozzle 18 attached thereto is then placed within inner void 38. Such placement also causes inner surface 50 of head portion 48 to engage seal ring 26. Further, second side 29 of ring 22 is closely positioned relative to side surface 55 of annular screen 24. Securing ring 16 is then threadably engaged to sprayer body 12 to retain the spray head 14 therein. As detailed further herein, closely positioned as used in connection with the side surfaces 55 and 57 of screen 24 relative to the side 29 and end 25 is defined to mean either abutting or spaced such that water therebetween generates sufficient surface tension to restrict flow perpendicular to screen 24. In one illustrative embodiment, such spacing is between 0.010 to 0.020 inches.

The diverter valve assembly and spray head 14 combination is configured to provide two distinct operational modes. In a first operational mode, water flows into first input passageway 40 (shown in FIG. 3) for delivery through spray outlets 23 of annular ring 22, thereby defining a first fluid outlet. In a second operational mode, the diverter valve assembly causes water to flow through a second input passageway 42 and through stream nozzle 18, thereby defining a second fluid outlet. In the illustrated embodiment, stream nozzle 18 provides a central stream of water surrounded by a continuous shield of water, the central stream having a substantially laminar flow. In an illustrative embodiment, the cartridge assembly is configured to provide only a central stream of water. In one illustrative example, the central stream is substantially laminar. In another illustrative example, the cartridge assembly includes an aerator and the central stream is an aerated stream.

It is envisioned that any diverter valve assembly that toggles between a plurality of operational modes may be used with spray head 14 of the present disclosure. Once such diverter valve assembly is described in U.S. patent application Ser. No. 11/702,867, filed Feb. 6, 2007, which has been incorporated herein by reference.

Referring to FIG. 3, passageway 40 is illustratively in fluid communication with and includes a plurality of conventional spray outlets 23 supported by annular ring 22 in a circular arrangement.

Stream nozzle 18 is concentrically and threadably or otherwise received within body 20 as shown in FIG. 3. Stream nozzle 18 is in fluid communication with passageway 42. Travel of water through passageway 42 and stream nozzle 18 may be performed by any known manner for sprayers, including the manner and structure described in the previously referenced U.S. patent application Ser. No. 11/702,867, filed Feb. 6, 2007, and in U.S. patent application Ser. No. 11/383,267, filed May 15, 2006, entitled “POWER SPRAYER,” the disclosures of which have been expressly incorporated by reference herein.

In an illustrative embodiment, the diverter valve assembly may be combined with the activation valve assembly for allowing spray device 10 to toggle between an off position where inlet 15 is not in communication with either passageway 40, 42, a spray position where the inlet 15 is in fluid communication with first input passageway 40, and a stream position where the water inlet 15 is in fluid communication with second input passageway 42. In a first operational mode, water flows into first input passageway 40 for delivery through spray outlets 23. In a second operational mode, water flows through second input passageway 42 and through stream nozzle 18.

With respect to the first operational mode and as shown in FIG. 3, water flows into first input passageway 40, travels around trunk portion 46, through annular channel 62 defined between insert 28 and trunk portion 46, radially outward via angled portion 45 and ultimately through screen 24, and then out spray outlets 23. Water is generally restricted from traveling across screen 24 perpendicularly to the plane of screen 24. Inner diameter of insert 28 and outer diameter of trunk portion 46 along channel 62 are chosen such that channel 62 is sized to have specific water handling characteristics. One such characteristic is that that when pressurized water is not supplied along channel 62 of the first flow pattern, the width of channel 62 allows the maintenance of surface tension of water remaining therein. Accordingly, upon diverter valve assembly assuming the off position resulting in disconnection of the supply of to pressurized water to channel 62, surface tension holds water remaining in channel 62 in place. For all portions of screen 24 that are closely positioned relative to end 25 of insert 28, such portions are closely positioned relative to second side 29 of annular ring 22. The close proximity of screen 24 with end 25 of insert 28 and with second side 29 of annular ring 22 also provides for surface tension to retain any water therebetween. Thus, all portions of screen 24 are closely positioned relative to, and in some embodiments may be abutted by, a parallel surface (either end 25 of insert 28 or second side 29 of annular ring 22) on at least one side 55 and 57. Such positioning and resulting water surface tension further restricts water flow perpendicular to screen 24. Screen 24 itself also provides surface tension between portions of itself. Water escaping or leaking from outlets 23 when the diverter valve is in the off position is thereby diminished.

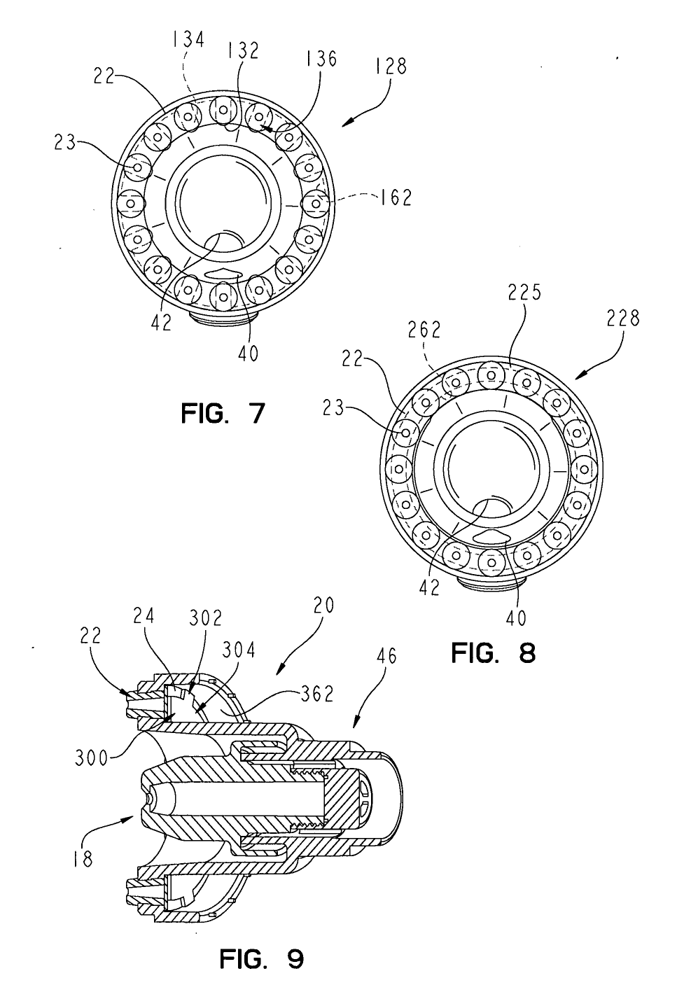

FIGS. 5 and 7 show a second embodiment insert 128. Insert 128 differs from insert 28 in that insert 128 includes a plurality of ribs 130. Ribs 130 align with respective spray outlets 23. Ribs 130 include inner edges 132 that abut trunk portion 46 of body 20 and define channels 162 between themselves. Channels 162 are larger than channels 62. Ribs 130 also provide outlet edges 134 that are closely positioned relative to screen 24, thereby creating surface tension within water positioned therebetween. Accordingly, the water flow path includes a portion that is within screen 24 and directs flow within the plane of screen 24. For all portions of screen 24 that are not closely positioned relative to outlet edges 134 of insert 128, such portions are closely positioned relative to annular ring 22. In such embodiments, surface tension is provided between screen 24 and outlet edges 134 to which screen 24 is closely positioned, between screen 24 and annular ring 22, and also between portions of screen 24 itself. Again, water escaping or leaking from outlets 23 is thereby diminished.

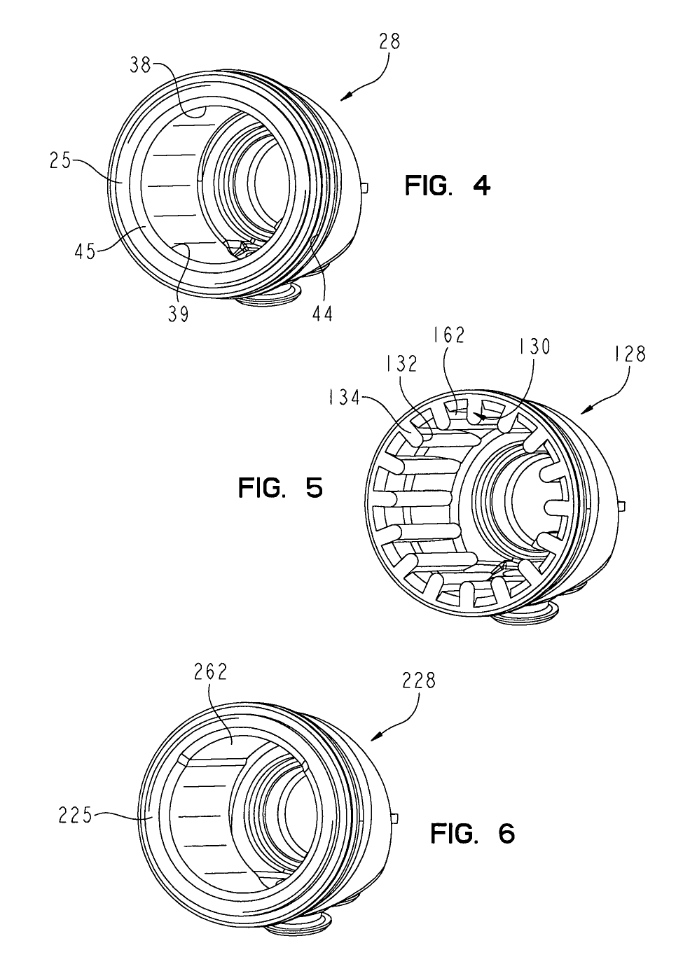

FIGS. 6 and 8 show a third embodiment insert 228. Insert 228 provides a first portion of the inner diameter 230 that is substantially equal to the diameter of trunk portion 46 to substantially prevent water travel therebetween under substantially all conditions. Insert 228 also provides a second portion of the inner diameter 232 that defines channel 262 between insert 228 and trunk portion 46. Once water travels through channel 262, it encounters screen 24. The water flow path includes a portion that is within screen 24 and directs flow within the plane of screen 24 and then ultimately out of spray outlets 23. Channel 262 is sized to allow surface tension to act on any non-pressurized water within channel 262 to retain the water therein. For all portions of screen 24 that do not abut end 225 of insert 228, such portions abut annular ring 22. Surface tension is thereby provided between screen 24 and end 225 of insert 228 to which screen 24 is abutted, between screen 24 and annular ring 22, and between portions of screen 24 itself. Again, water escaping or leaking from outlets 23 is thereby diminished.

FIG. 9 shows body 20, annular ring 22, screen 24, and gasket 300. Annular gasket 300 is formed from rubber and includes alternating first sections 302 and second sections 304. First sections 302 have a width that is substantially equal to the width of screen 24, while second sections 304 have a width substantially less than the width of screen 24. Gasket 300 may be used during original manufacture or as a retrofit application to sprayers such as those described in the previously referenced U.S. patent application Ser. No. 11/702,867. Gasket 300 abuts screen 24. Water within channel 362 may travel to screen 24 via the space afforded by the diminished width of second sections 304 of gasket 300. For all portions of screen 24 that do not abut gasket 300, such portions abut annular ring 22. When pressurized water is not being supplied within channel 362 and water remains within channel 362, surface tension between screen 24 and gasket 300, between screen 24 and annular ring 22, and within screen 24 itself diminishes escaping or leaking from outlets 23.

The spray devices discussed herein may be used as apart of a water delivery system, such as a faucet, for use with a sink having a drain or other device, residential or commercial, associated with a drain. Such a water delivery system is illustratively coupled to a source of hot water and a source of cold water. Water from the source of hot water and source of cold water are provided to one or more valves, upstream from inlet 15 of spray device 10, which may be adjusted to regulate the flow of water there through.

In one embodiment, the source of hot water and the source of cold water are both in fluid communication with a single mixing valve (not shown) which regulates the flow rate of water from each source which is to be provided to an output device, if any, depending on the water characteristics desired. For instance, only hot water may be desired so the valve would only pass water from the source of hot water. In another embodiment, the source of hot water and the source of cold water are each in fluid communication with a respective valve, each valve regulating the flow of water to be provided to the output device from the respective source of water in fluid communication with the valve. The valve may be positioned above a sink deck or below the sink deck.

The control of the valve is through one or more input devices. Exemplary input devices include both mechanical input devices, such as handles, and electronic input devices, such as a touch sensor or an infrared sensor, which provide an indication to a controller of the water characteristics desired. In one example, the controller adjusts valve through a motor coupled to valve.

Exemplary output devices include a spout having spray device 10 coupled thereto. The spout may be rigid or may have a flexible portion. In one embodiment, spray device 10 is a swivel head attached to the end of a spout base member. Any of the spray devices disclosed herein may be used as a swivel head. In one embodiment, spray device 10 is a pull out wand which is attached to a spout base member. Any of the spray devices disclosed herein may be used as a pull-out wand. The pull out wand having a first position generally coupled to spout base member and a second position wherein the wand is spaced apart from the spout base member and connected thereto through a waterway connecting the two. In another exemplary embodiment, any of the spray devices disclosed herein may be an output device which is a side spray.

In one embodiment, water delivery system is associated with a bathtub, a shower, or other receptacle having an associated drain. As such, the spray devices disclosed herein may be used as a hand-held spray device with a bathtub or shower.

In one embodiment, each of the spray devices disclosed herein are configured to permit water to be provided to the first water outlet and the second water outlet simultaneously as described in U.S. patent application Ser. No. 11/702,867.

Although the invention has been described in detail with reference to certain preferred embodiments, variations and modifications exist within the spirit and scope of the invention as described and defined in the following claims.

1. A spray device, comprising:
a body having a fluid inlet and a first fluid outlet selectively in fluid communication with the fluid inlet; and
a substantially planar screen extending within a first plane, the spray device defining a flow path between the fluid inlet and the first fluid outlet, the flow path including a portion within the screen such that fluid is directed substantially along the first plane before passing through the first fluid outlet.

2. The spray device of claim 1, wherein the flow path includes a portion within the screen having a width substantially equal to the width of the screen.

3. The spray device of claim 1, wherein the flow path is sized and shaped to restrict flow through the screen from being perpendicular to the first plane.

4. The spray device of claim 1, further including a second fluid outlet selectively in fluid communication with the fluid inlet.

5. The spray device of claim 4, wherein the flow path is sized such that fluid is held within the flow path when the first fluid outlet is placed out of fluid communication with the fluid inlet.

6. The spray device of claim 1, wherein the first fluid outlet includes a plurality of outlets.

7. A spray device, comprising:
a body supporting first and second substantially planar surfaces; and
a substantially planar screen supported within the body, defining a first plane and having first and second sides, wherein all portions of the screen are closely positioned on at least one of the first and second sides relative to one of the first and second substantially planar surfaces, the first and second substantially planar surfaces extending parallel to the first plane, such that fluid flow through the screen is substantially directed parallel to the first plane.

8. The spray device of claim 7, further including a first fluid outlet selectively in fluid communication with a fluid inlet via a fluid path, the screen being positioned in the fluid path.

9. The spray device of claim 7, further including a flow path within the body extending between a fluid inlet and a fluid outlet such that travel between the fluid inlet and fluid outlet requires travel though the screen.

10. The spray device of claim 7, further including a flow path within the body extending between a fluid inlet and a fluid outlet such that travel across the screen is restricted from being outside of the first plane.

11. The spray device of claim 7, further including a flow path within the body between a fluid inlet and a fluid outlet such that travel in the screen and in the first plane is required to travel from the fluid inlet to the fluid outlet.

12. The spray device of claim 7, wherein the first and second sides of the screen are closely positioned relative to the first and second substantially planar surfaces such that any spacing therebetween generates adequate fluid surface tension to restrict fluid flow perpendicular to the first plane.

13. A method of increasing sites for surface tension within a spray device including the steps of:
providing a hand-held sprayer body including an inlet and an outlet; and
providing a gasket within the sprayer body to alter a flow path within the spray device from the inlet to the outlet.

14. The method of claim 13, further including the step of abutting the gasket to a screen.

15. The method of claim 14, wherein the screen defines a first plane and the step of placing the gasket restricts water from traveling through the screen perpendicularly to the first plane.

16. The method of claim 13, wherein the step of providing a gasket includes the step of providing a substantially planar gasket.

17. The method of claim 13, wherein the step of providing a gasket includes the step of providing a substantially annular gasket.

18. The method of claim 17, wherein the step of providing a gasket includes the step of providing a gasket having portions of different widths.

19. The method of claim 18, further including the step of abutting the gasket to a screen.

20. The method of claim 19, wherein the portions of different widths include portions having a width smaller than the width of the screen.

21. The method of claim 20, further including the step of abutting the screen to a surface such that the screen is abutted on at least one side by at least one of the surface and the gasket.
